(19) United States
(12) Patent Application Publication
(10) Pub. No.: US 2026/0023676 A1
(43) Pub. Date: Jan. 22, 2026

(54) SYSTEM AND METHODS FOR CONTEXTUAL DEBUGGING OF COMPUTER PROGRAMS

(71) Applicant: Shopify Inc., Ottawa (CA)

(72) Inventors: Paul NUSCHKE, Wallingford, PA (US); Cameron BARKER, Newport Beach, CA (US); Ryan ISCHE, Stratford (CA); Steven LOW, Kitchener (CA)

(73) Assignee: Shopify Inc., Ottawa, ON (CA)

(21) Appl. No.: 18/776,667

(22) Filed: Jul. 18, 2024

(51) Int. Cl. G06F 11/36

(52) U.S. Cl. CPC G06F 11/3636

(57) ABSTRACT

A computer-implemented method is disclosed. The method includes: obtaining a stack trace associated with an error detected in connection with execution of a computer program by a processor; determining a location of the error within source code of the computer program based on the stack trace, wherein the source code contains a template code section and a custom code section; generating an error message for the error, wherein the generating includes: in response to determining that the error is located in the custom code section, appending a first representation of the stack trace to the error message; and in response to determining that the error is located in the template code section, formatting the error message to indicate a generic template code error, and presenting the error message via a computing device.

### TECHNICAL FIELD

The present application relates to software development and, more particularly, to a system and methods for debugging computer programs.

### BACKGROUND

Debugging tools enable developers to monitor execution of a computer program and identify error(s) that are generated during execution. The error information is typically conveyed in a message that indicates, for example, an error type (e.g., syntax error, runtime error, etc.), a location of the error in the source code, and a brief description of the error. As the complexity of a computer program increases, the task of determining the root cause of an error becomes more challenging.

### BRIEF DESCRIPTION OF THE DRAWINGS

Embodiments are described in detail below, with reference to the following drawings:

FIG. 1 is a schematic diagram illustrating an example configuration of a computing environment;

FIG. 2A is high-level schematic diagram of an example computing device;

FIG. 2B shows a simplified organization of software components stored in a memory of the example computing device of FIG. 2A;

FIG. 3 shows, in flowchart form, an example method for generating contextual debug messages in connection with a computer program;

FIG. 4 shows, in flowchart form, another example method for generating contextual debug messages in connection with a computer program;

FIG. 5 shows, in flowchart form, an example method for debugging automated workflow execution on an e-commerce platform;

FIG. 6 is a block diagram of an e-commerce platform, in accordance with an example embodiment; and

FIG. 7 is an example of a home page of an administrator, in accordance with an example embodiment.

Like reference numerals are used in the drawings to denote like elements and features.

### DETAILED DESCRIPTION OF VARIOUS EMBODIMENTS

In an aspect, the present disclosure describes a computer-implemented method. The method may include: obtaining a stack trace associated with an error detected in connection with execution of a computer program by a processor; determining a location of the error within source code of the computer program based on the stack trace, wherein the source code contains a template code section and a custom code section; generating an error message for the error, wherein the generating includes: in response to determining that the error is located in the custom code section, appending a first representation of the stack trace to the error message; and in response to determining that the error is located in the template code section, formatting the error message to indicate a generic template code error, and presenting the error message via a computing device.

In some implementations, generating the error message may further include parsing the stack trace to identify: a first trace portion corresponding to execution of the custom code section; and a second trace portion corresponding to execution of the template code section.

In some implementations, the method may further include determining relative line reference data that indicates line numbering relative to the custom code section, and the first representation may be obtained based on modifying the first trace portion of the stack trace using the relative line reference data.

In some implementations, the relative line reference data may comprise line numbers in a custom code file containing the custom code section and not containing the template code section.

In some implementations, the method may further include storing, in memory, at least one of: the relative line reference data, or line number offset for the custom code section relative to source code line numbering.

In some implementations, formatting the error message to indicate the generic template code error may include selectively including, in the error message, information from the second trace portion of the stack trace.

In some implementations, formatting the error message to indicate the generic template code error may include: determining a modified representation of the second trace portion of the stack trace; and inserting the modified representation in the error message.

In some implementations, determining the modified representation may include deleting one or more lines from the second trace portion of the stack trace.

In some implementations, determining the modified representation may include: determining generic indicators of one or more active routines that are defined in the template code section of the source code; and replacing at least parts of the second trace portion with the generic indicators.

In some implementations, the method may further include obtaining a source map that is generated based on the source code, and the location of the error within the source code may be determined based on: the source map; and indications of stack trace portions corresponding to execution of the custom code section and the template code section, respectively, of the source code.

In another aspect, the present disclosure describes a computing system. The computing system includes a processor and a memory coupled to the processor. The memory stores computer-executable instructions that, when executed by the processor, may configure the processor to:

obtain a stack trace associated with an error detected in connection with execution of a computer program by a processor; determine a location of the error within source code of the computer program based on the stack trace, wherein the source code contains a template code section and a custom code section; generate an error message for the error, wherein the generating includes: in response to determining that the error is located in the custom code section, append a first representation of the stack trace to the error message; and in response to determining that the error is located in the template code section, format the error message to indicate a generic template code error, and present the error message via a computing device.

In yet another aspect, a non-transitory computer-readable medium is disclosed. The computer-readable medium stores instructions that, when executed by a processor, configure the processor to: obtain a stack trace associated with an error detected in connection with execution of a computer program by a processor; determine a location of the error within source code of the computer program based on the stack trace, wherein the source code contains a template code section and a custom code section; generate an error message for the error, wherein the generating includes: in response to determining that the error is located in the custom code section, append a first representation of the stack trace to the error message; and in response to determining that the error is located in the template code section, format the error message to indicate a generic template code error, and present the error message via a computing device.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

A workflow is a structured sequence of steps. Workflow automation refers to automating the execution of steps that are associated with a task or process. Workflows may be defined using workflow components such as triggers, conditions, and actions. A trigger is an event that starts a workflow. When a trigger for a defined workflow is detected, one or more conditions associated with the trigger are evaluated. Conditions can check against properties of a trigger event (e.g., date and time of event) as well as properties of subjects or objects that are involved in the event (e.g., customer name, product order number, etc.). If a certain condition is fulfilled, the corresponding action, or sequence of actions, is automatically executed.

In the context of an e-commerce platform, merchants using the platform can define workflows for automating tasks and processes within their online store or across various tools/apps that are connected to the store. For example, when a new order is placed by a customer through a merchant's online storefront, a workflow may be run automatically to execute certain actions based on the new order. The workflow may include actions that, for example, change something in the storefront (e.g., adding a product variant to an order, capturing payment for an order, etc.), or send commands to a connected app (e.g., instructing an app to send push notifications to a customer). A workflow automation system for the e-commerce platform may monitor merchants' stores for triggers and enable merchants to define automated sequences of actions that are taken in response to detected triggers.

Workflows may be created using customizable actions. In particular, merchants may be able to author their own custom logic for an action and not be limited, for example, to selecting from a predefined list of actions. A “run code” action (or similar implementation) may execute computer code that is written by a merchant. A merchant can provide code, using a programming language, that is executed as part of a workflow. The “run code” action takes data from previous steps in the workflow as input, and returns custom data that can be used in subsequent steps of the workflow. The “run code” action enables merchants to personalize workflows and tailor automation to fit their unique needs.

The merchant's logic, represented in custom code, is inserted into a source code template, and the merged source code (i.e., combination of custom and template code) is executed in the workflow. The template code comprises predefined source code surrounding the merchant's custom code for processing input and output data. For example, the template code may define functions or subroutines for setup, preparation, translation, formatting, teardown, cleanup, etc. of data from one or more workflow steps. The custom code, authored by the merchant, is a snippet of logic that is executed along with the template code.

Debugging the custom code presents challenges. Firstly, where the merged source code is complex, error notifications for an error that is rooted in the custom code may be prone to including incorrect or superfluous information. Secondly, debugging information (e.g., stack trace) can reveal a significant amount of information about the system/platform that implements the template code, some of which is not intended to be made available to developers (and more generally, third-party entities). For example, the debugging information may disclose or suggest information regarding design decisions for the underlying system/platform such as, but not limited to, encryption algorithms implemented, existing paths on application server(s), internal references for objects, version and/or brand of databases used, and the like.

The present application proposes a solution that facilitates effective debugging in the context of computer programs containing both template (e.g., platform) code and custom developer code. The proposed system and methods support generating error messages for developers that minimizes the risk of including incorrect or security-relevant information. More particularly, the proposed solution provides accurate line reference data in debugging information and suppresses information on errors that are rooted in template/platform code.

A source map for a computer program is generated based on source code comprising a combination of template code and custom developer code. The source map may, for example, represent a minified version of the original source code. Functionally, the source map contains information about how the compiled code maps to the original code. Lines and locations in the compiled file are mapped to the corresponding original file. In at least some implementations, line number offsets may be recorded to track the line numbers that are used in the developer view of the source code. Each “run code” action may be associated with a standalone script and its own source map.

An error may be generated when the source code is executed (interpreted or after compilation). The stack trace or error message maps to certain source code line numbers. It is then determined where the error is located, i.e., in the template code section of the merged source code, or the custom code section of the merged source code. Based on this determination, either a full stack trace may be provided to the developer, if the error is in the custom code section, or a “sanitized” error message may be provided. The sanitized error message is provided if the error occurred in the template code section. The error message may be formatted such that the line numbers cited in the error message are mapped to the developer view of the source code file (and not the merged file that was compiled or executed).

In at least some implementations, the sanitized error message may comprise a formatted version of the stack trace. In particular, the stack trace may be parsed to remove certain sections, for example, that are irrelevant and/or intended to be hidden from the developer. The sanitized error message is generated based on information contained in the source map, the stack trace, and a mapping of sections of the stack trace to template/platform and custom code sections of the source code

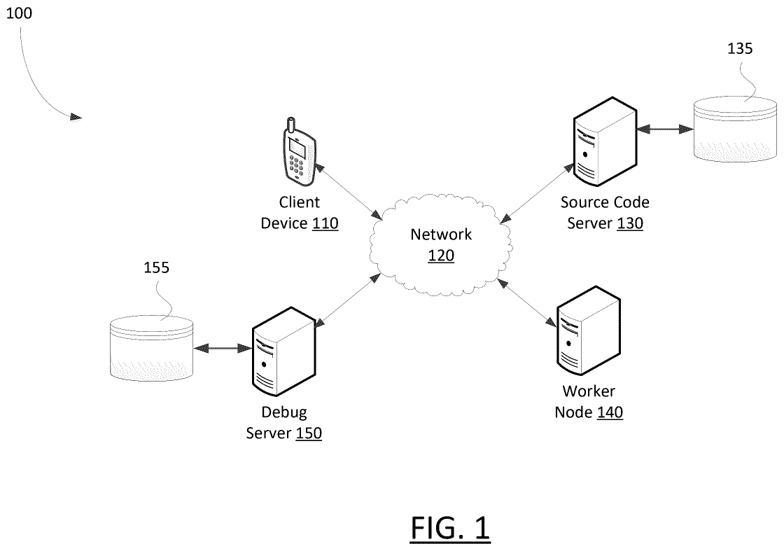

Reference is first made to FIG. 1, which is a schematic diagram illustrating an example configuration of a computing environment. FIG. 1 illustrates exemplary components of a system 100 for managing distributed execution of computer programs. As a specific example, the system 100 may be implemented to facilitate automated execution of workflows in a distributed environment.

The system 100 includes client devices 110, a source code server 130, a database 135 associated with the source code server 130, one or more worker nodes 140, and a debug server 150. In some implementations, the components of system 100 may form part of a single computing system. By way of example, a computing system implementing an e-commerce platform may integrate one or more of the illustrated components of system 100. The e-commerce platform may be used to provide merchant products and services to customers. The components of system 100 may enable automating workflows relating to services provided by merchants via the e-commerce platform. Examples of customer service workflows which may be implemented by an e-commerce platform include customer onboarding workflows, order and cart workflows, issue resolution workflows, and customer feedback workflows.

As shown in FIG. 1, the system 100 includes a source code server 130. The source code server 130 is configured to process workflows and automate scheduling of jobs associated with the workflows. In particular, the source code server 130 may implement a workflow management service or system for managing source codes (e.g., template code, custom code, etc.) of workflows for execution. Further, the source code server 130 may be configured to compile, minify, or otherwise transform source code into different executable formats, such as WebAssembly. The source code server 130 may include a job scheduler for handling the scheduling of jobs. Workflows may relate, for example, to user journeys or flows capturing how users interact with an application or service. A given workflow includes a plurality of steps. The function of the job scheduler is to determine how to assign the steps of a workflow to executable jobs.

The source code server 130 is communicably coupled to a database 135. The database 135 stores application data associated with the third-party application/service as well as data that supports the job scheduling functionality of the source code server 130. For example, the database 135 may store user data, application preferences and settings, workflow data of one or more workflows, list of jobs, job information (e.g., job type, set of steps, etc.) and status, list of available worker nodes, assignments of jobs to worker nodes, and the like.

The system 100 includes one or more worker nodes 140. Each worker node 140 may be a computer system and more generally, a node in a distributed system. The worker nodes 140 communicate with the source code server 130 and may each be configured to execute jobs assigned by a job scheduler of the source code server 130. A worker node 140 executes the workflow step(s) of an assigned job on receiving a command from the job scheduler by, for example, executing a workflow runtime function. The command may indicate, for example, details of the job, including description of the workflow steps. The worker node 140 may provide a status update comprising results of the job execution, and the job scheduler may store the status update in the database 135.

The client devices 110, the source code server 130, the worker nodes 140, and the debug server 150 may be in geographically disparate locations. Put differently, the source code server 130 may be remote from the client devices 110, the worker nodes 140, and the debug server. As explained herein, the client device 110, the source code server 130, the worker nodes 140, and the debug server 150 are computer systems.

The network 120 is a computer network. In some implementations, the network 120 may be an internetwork such as may be formed of one or more interconnected computer networks. For example, the network 120 may be or may include an Ethernet network, an asynchronous transfer mode network, a wireless network, or the like.

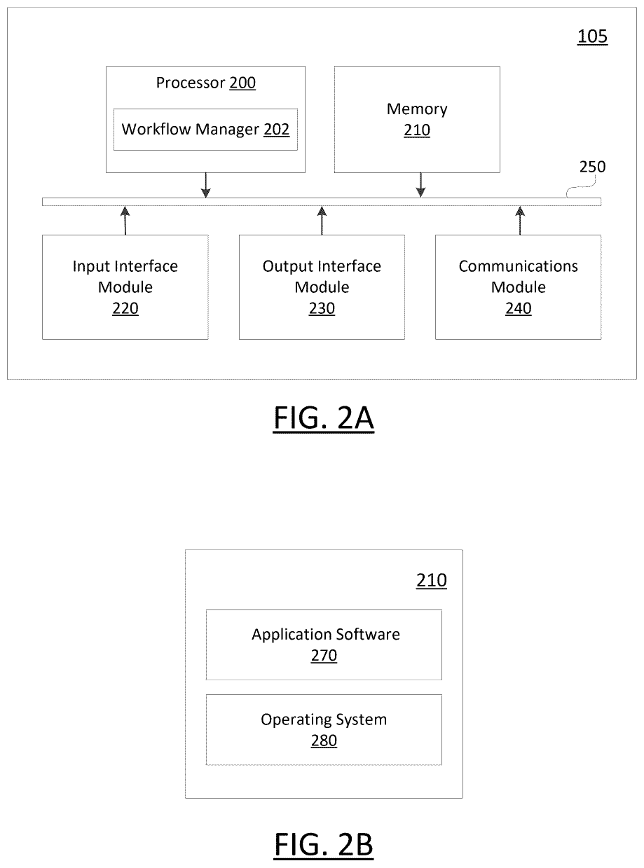

FIG. 2A is a high-level operation diagram of an example computing device 105. In at least some implementations, the example computing device 105 may be exemplary of the client devices 110, the source code server 130, and the worker nodes 150. The example computing device 105 includes a variety of modules. For example, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. For example, the processor 200 may comprise one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned examples of input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like.

Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. The operating system 280 is software. The operating system 280 allows the application software 270 to access the processor 200, the memory 210, the input interface module 220, the output interface module 230 and the communications module 240. The operating system 280 may be, for example, Apple iOS™, Google's Android™, Linux™, Microsoft Windows™, or the like.

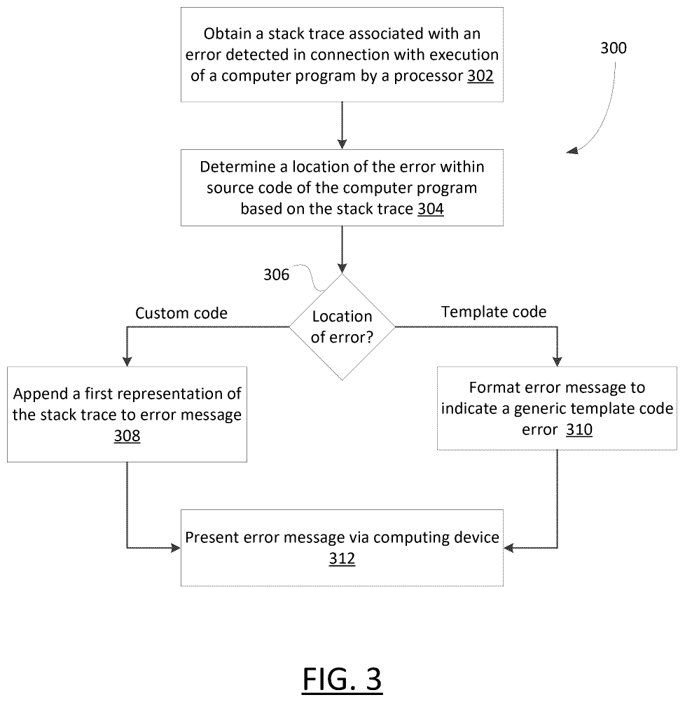

Reference is now made to FIG. 3, which shows, in flowchart form, an example method 300 for generating contextual debug messages in connection with a computer program. The operations of method 300 may be performed when debugging a computer program whose source code contains both template and custom codes. In some embodiments, the method 300 may be implemented by a computer system that is configured to execute jobs/steps of a workflow in a distributed system. For example, the operations of method 300 may be performed by a worker computing system (such as the worker node 140 of FIG. 1) when executing a runtime function associated with a workflow.

The source code of the computer program includes a template code section and a custom code section. In particular, the source code may be a merge/combination of custom code provided by a developer and template code for a system/platform. For example, the custom code may be inserted into a template code file that includes definitions of functions and subroutines for processing input and output data associated with the custom code. The computer program is executed by the worker node, and an error is generated. In operation 302, the worker node obtains a stack trace associated with the error. The stack trace represents a snapshot of the call stack at a certain point in time during execution of the computer program, and includes one or more active stack frames corresponding to function calls within the computer program. In at least some implementations, the stack trace may be generated automatically upon execution of the computer program.

The worker node determines a location of the error within the source code of the computer program, in operation 304. In particular, the error location is determined based on the stack trace. In at least some implementations, the stack trace maps to specific lines of the source code. That is, the stack trace indicates the line(s) in the source code where the error occurred. The stack trace data may include, for example, the line number for the error, identifier of the function/subroutine that caused the error, and the error type. In the case of chained exceptions, the stack trace data may indicate the location of the root cause of the error.

An error message for the error is generated by the worker node. The content and format of the error message depends on the location of the error within the source code of the computer program. In particular, the worker node determines the section of the source code, i.e., custom code section or template code section, in which the error is located (operation 306). The error message may include debugging information. In at least some implementations, the worker node may parse the stack trace to identify portions of the stack trace corresponding to the custom code and template code sections, respectively. More specifically, the worker node may be configured to identify a first trace portion corresponding to execution of the custom code and a second trace portion corresponding to execution of the template code. The trace portions include debugging information about the error that may be suitable for selectively presenting in the error message.

If the worker node determines that the error is located in the custom code, the worker node appends a first representation of the stack trace to the error message (operation 308). In some implementations, the first representation may comprise the entire stack trace. For example, the stack trace may only include stack frames corresponding to functions/subroutines that are defined in the custom code. If the stack trace only includes debugging information for the custom code, it may be suitable for presenting as-is (or slightly modified) in the error message. Alternatively, the first representation may include the first trace portion of the stack trace. The first trace portion corresponds to execution of the custom code. The first representation explicitly excludes debugging information associated with execution of the template code. That is, any debugging information relating to the template code in the stack trace may be intentionally excluded from the error message.

A developer may view and edit only the custom code of the computer program. In particular, they may not have access to read and/or edit to the template code. As such, the line reference data of the custom code file, accessed by the developer, is different from the line reference data of the merged code file, which contains the combined custom and template code. The worker node is configured to reconcile these differences, by processing the stack trace and determining relative line reference data of debugging information. The relative line reference data indicates line numbering relative to the custom code section of the source code. The relative line reference data may, for example, comprise line numbers that may be found in a custom file containing only the custom code section of the source code (and not the template code section). In some implementations, the stack trace data presented in the error message to the developer may indicate the relative line reference data, i.e., adjusted line numbers.

On the other hand, if the error is determined to be located in the template code, the worker node formats the error message to indicate a generic template code error, in operation 310. In particular, the worker node may be configured to suppress certain debugging information for the error when generating the error message. For example, the debugging information contained in the stack trace relating to the template code may be at least partially suppressed. In some implementations, the error message may include selective information from the second trace portion of the stack trace. That is, the debugging information relating to execution of the template code may be selectively included in the error message. For example, only information that does not disclose or suggest specific design and implementation details may be added to the error message. Such non-sensitive debugging information may be predetermined. Other information in the second trace portion, e.g., line numbers, function/subroutine names, etc., may be intentionally excluded.

In some implementations, the worker node may determine a modified representation of the second trace portion of the stack trace and insert the modified representation in the error message. For example, the modified representation may be obtained by deleting one or more lines from the second trace portion. The deleted lines may, for example, correspond to sensitive platform-specific information that is desired to be excluded from debugging information. Additionally, or alternatively, the modified representation may be obtained by determining generic indicators of one or more active routines that are defined in the template code section of the source code and replacing at least parts of the second trace portion with the generic indicators. That is, the modified representation may include alternate names, or identifiers, of functions or subroutines that are defined as part of the template code. In this way, the modified representation may serve to anonymize certain sensitive information relating to design, implementation details, etc., which may be suggested by the stack trace.

The generated error message is then presented via a computing device (operation 312). For example, the error message may be presented on a computing device of a developer that authors the custom code. A developer may receive the error message when testing their custom code (e.g., program code that executes automatically during a step in a workflow) locally prior to integration with the template code for creating a bundled source code.

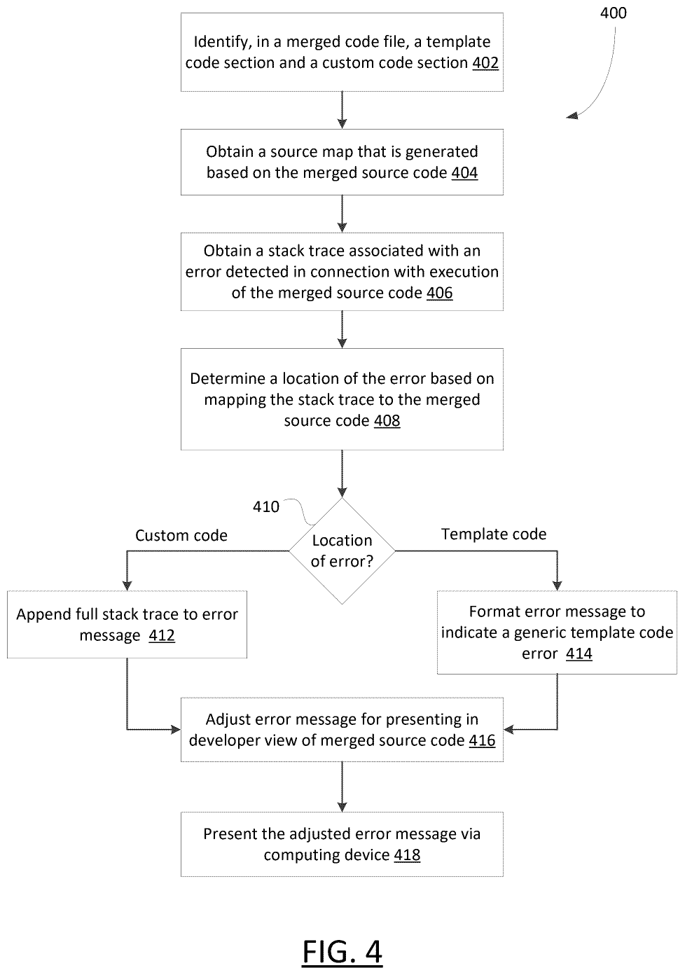

Reference is now made to FIG. 4, which shows, in flowchart form, another example method 400 for generating contextual debug messages in connection with a computer program. The operations of method 400 may be performed when debugging a computer program whose source code contains both template and custom codes. In some embodiments, the method 400 may be implemented by a computer system that is configured to execute jobs/steps of a workflow in a distributed system. For example, the operations of method 400 may be performed by a worker computing system (such as the worker node 140 of FIG. 1) when executing a runtime function associated with a workflow. The operations of method 400 may be performed in addition to, or as alternatives of, one or more of the operations of method 300.

The source code of a computer program includes both template code and custom code. For example, the custom code may be inserted into a template code file that includes definitions of functions and subroutines for processing input and output data associated with the custom code. A worker node identifies, in a merged code file containing the source code, a template code section and a custom code section (operation 402).

In certain instances, the merged source code may be compiled, minified, compressed, or otherwise transformed to a different format. For example, various programs that are written in high-level languages may be compiled to a portable binary-code format, such as WebAssembly, that enables deployment on the web for client and server applications. In operation 404, the worker node obtains a source map for the computer program. The source map may be obtained, for example, using a build tool that is used to transform the original source code. The source map provides a way to reconstruct the original source based on the transformed code, and present the reconstructed original in a debugger.

The transformed code of the computer program is executed by the worker node, and an error is generated. In operation 406, the worker node obtains a stack trace associated with an error that is detected in connection with execution of the computer program. The worker node determines a location of the error by mapping the stack trace to the original source code. In particular, the error location is determined based on the source map and indications of stack trace portions corresponding to execution of the custom code section and the template code section, respectively, of the original source code.

The worker node determines whether the error is located in the custom code section or the template code section. In the former case, the worker node is configured to append the entire stack trace (or a similar representation of the stack trace) to the error message (operation 412). For example, the stack trace may only include stack frames corresponding to functions/subroutines that are defined in the custom code. If the stack trace only includes debugging information for the custom code, it may be suitable for presenting as-is (or slightly modified) in the error message. Alternatively, the worker node may determine portions of the stack trace corresponding to the custom code execution, and only include those portions in the error message. Any debugging information relating to the template code in the stack trace may be intentionally excluded from the error message.

On the other hand, if the error is determined to be located in the template code section, the worker node formats the error message to indicate a generic template code error (operation 414). In particular, the worker node suppresses certain debugging information for the error when generating the error message. For example, the debugging information contained in the stack trace relating to the template code may be at least partially suppressed. In some implementations, the error message may include selective information from the second trace portion of the stack trace. That is, the debugging information relating to execution of the template code may be selectively included in the error message. For example, only information that does not disclose or suggest specific design and implementation details may be added to the error message. Other information in the second trace portion, e.g., line numbers, function/subroutine names, etc., may be intentionally excluded.

In some implementations, the worker node may determine a modified representation of the second trace portion of the stack trace and insert the modified representation in the error message. For example, the modified representation may be obtained by deleting one or more lines from the second trace portion. Additionally, or alternatively, the modified representation may be obtained by determining generic indicators of one or more active routines that are defined in the template code section of the source code and replacing at least parts of the second trace portion with the generic indicators. That is, the modified representation may serve to anonymize any sensitive information relating to design, implementation details, etc., which may be suggested by the stack trace.

In operation 416, the worker node configures the error message for presenting in a developer view of the merged source code. The developer view of the source code may enable the merchant to view and edit only the custom code section. The worker node may determine relative line reference data indicating line numbering relative to the custom code section. In particular, the relative line reference data comprises line numbers in a custom code file containing the custom code section and not containing the template code section. In some implementations, the relative line reference data and/or line number offset for the custom code section relative to source code line numbering may be stored in memory.

The configured error message is then presented via a computing device (operation 418). For example, the configured error message may be presented on a computing device of a developer that provides the custom code. A developer may receive the configured error message when testing their custom code prior to integration with the template code

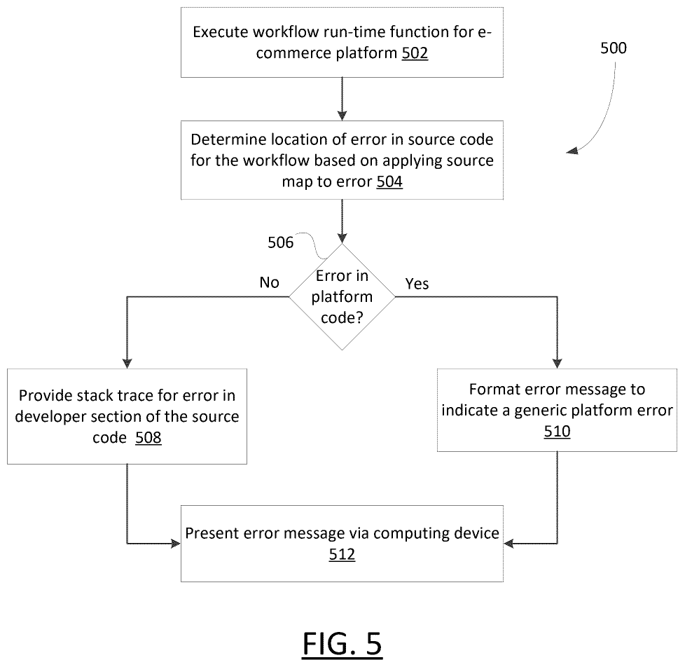

Reference is now made to FIG. 5, which shows, in flowchart form, an example method 500 for debugging automated workflow execution on an e-commerce platform. The method 500 may be implemented by a computer system that is configured to control execution of jobs in a distributed system. As a specific example, the operations of method 500 may be performed by a worker computing system (such as worker node 140 of FIG. 1) when executing a workflow runtime function. The operations of method 500 may be performed in addition to, or as alternatives of, one or more of the operations of methods 300 and 400.

As described above, a workflow for an e-commerce platform may be defined by triggers and conditional actions associated with the triggers. A “run code” action (or similar implementation) may enable merchants to personalize workflows and tailor automation, by allowing merchants to provide customized source code for execution as part of a workflow.

In operation 502, a worker node executes a workflow runtime function for an e-commerce platform. The function may comprise jobs of a defined workflow which may include conditional evaluations and actions. The source code for the function may include both custom code provided by a merchant and platform code associated with the e-commerce platform. For example, the custom code may be inserted in a platform code file that includes definitions of subroutines for processing input and output data associated with the custom code.

An error may be generated during execution of the workflow, i.e., during execution of the workflow runtime function. In operation 504, the worker node determines the location of the error in the source code of the computer program. The error may be located by using any of the methods described above. In at least some implementations, the worker node may obtain a source map for the workflow runtime function that allows for reconstructing the original source code associated with the workflow. The source map can be used in conjunction with a stack trace that is generated for the error in order to determine the error location. In particular, the worker node is configured to determine the error location based on, at least, the source map and the stack trace.

The worker node determines whether the error is located in the platform code section of the source code (operation 506). If the error is in the platform code, the worker node formats the error message to indicate a generic platform/template error (operation 510). Otherwise, if the error is in the developer code section, the worker node may provide the entire stack trace for the error, in operation 508. For the latter scenario, the stack trace would not contain platform code-specific information. The formatting of the error message may be performed in accordance with any of the methods described above.

The error message is then presented via a computing device, in operation 512. For example, the error message may be presented on a computing device of a developer when testing and debugging custom code provided by the developer.

### Example E-commerce Platform

Although integration with a commerce platform is not required, in some embodiments, the methods disclosed herein may be performed on or in association with a commerce platform such as an e-commerce platform. Therefore, an example of a commerce platform will be described.

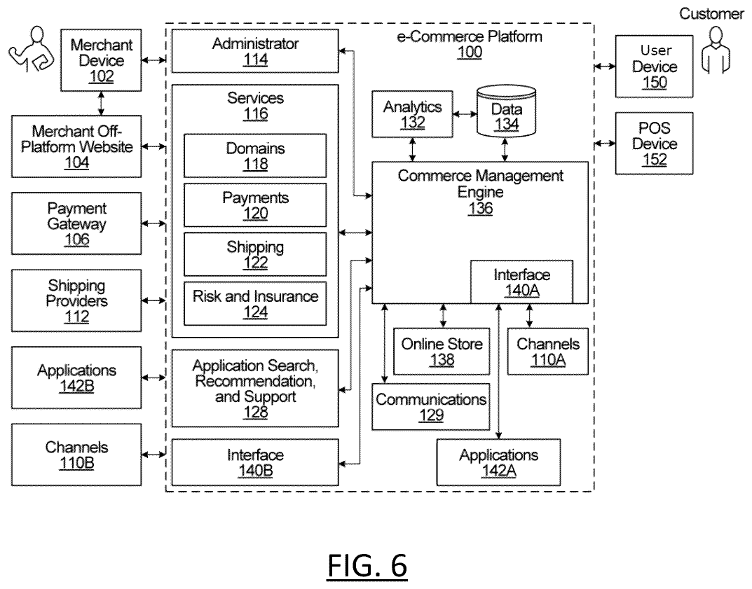

FIG. 6 illustrates an example e-commerce platform 100, according to one embodiment. The e-commerce platform 100 may be exemplary of the e-commerce platform 105 described with reference to FIG. 2. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 6, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like). The example computing device 200 of FIG. 1 may be exemplary of each POS device 152. In particular, the POS devices 152 associated with the e-commerce platform 100 may be configured to implement any one or more of the example methods 300 to 600 described above with reference to FIGS. 3 to 6.

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (Saas), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

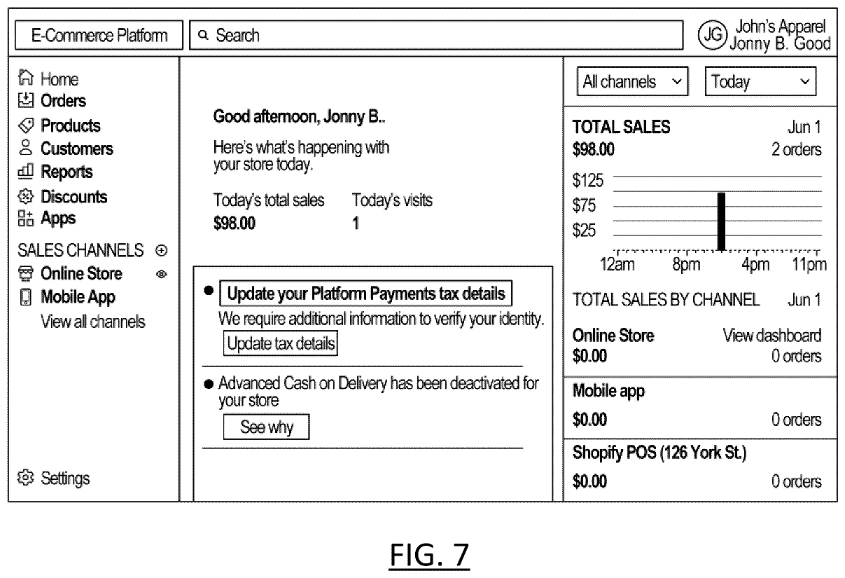

FIG. 7 depicts a non-limiting embodiment for a home page of an administrator 114.

The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 7. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 7, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
obtaining a stack trace associated with an error detected in connection with execution of a computer program by a processor;
determining a location of the error within source code of the computer program based on the stack trace, wherein the source code contains a template code section and a custom code section;
generating an error message for the error, wherein the generating includes:
in response to determining that the error is located in the custom code section, appending a first representation of the stack trace to the error message; and
in response to determining that the error is located in the template code section, formatting the error message to indicate a generic template code error, and
presenting the error message via a computing device.

2. The method of claim 1, wherein generating the error message further comprises parsing the stack trace to identify:
a first trace portion corresponding to execution of the custom code section; and
a second trace portion corresponding to execution of the template code section.

3. The method of claim 2, further comprising determining relative line reference data that indicates line numbering relative to the custom code section, wherein the first representation is obtained based on modifying the first trace portion of the stack trace using the relative line reference data.

4. The method of claim 3, wherein the relative line reference data comprises line numbers in a custom code file containing the custom code section and not containing the template code section.

5. The method of claim 3, further comprising storing, in memory, at least one of: the relative line reference data, or line number offset for the custom code section relative to source code line numbering.

6. The method of claim 2, wherein formatting the error message to indicate the generic template code error comprises selectively including, in the error message, information from the second trace portion of the stack trace.

7. The method of claim 2, wherein formatting the error message to indicate the generic template code error comprises:
determining a modified representation of the second trace portion of the stack trace; and
inserting the modified representation in the error message.

8. The method of claim 7, wherein determining the modified representation comprises deleting one or more lines from the second trace portion of the stack trace.

9. The method of claim 7, wherein determining the modified representation comprises:
determining generic indicators of one or more active routines that are defined in the template code section of the source code; and
replacing at least parts of the second trace portion with the generic indicators.

10. The method of claim 1, further comprising obtaining a source map that is generated based on the source code, wherein the location of the error within the source code is determined based on:
the source map; and
indications of stack trace portions corresponding to execution of the custom code section and the template code section, respectively, of the source code.

11. A computing system, comprising:
a processor;
a memory coupled to the processor, the memory storing processor-executable instructions that, when executed by the processor, configure the processor to:
obtain a stack trace associated with an error detected in connection with execution of a computer program by a processor;
determine a location of the error within source code of the computer program based on the stack trace, wherein the source code contains a template code section and a custom code section;
generate an error message for the error, wherein the generating includes:
in response to determining that the error is located in the custom code section, append a first representation of the stack trace to the error message; and
in response to determining that the error is located in the template code section, format the error message to indicate a generic template code error, and
present the error message via a computing device.

12. The computing system of claim 11, wherein generating the error message further comprises parsing the stack trace to identify:
a first trace portion corresponding to execution of the custom code section; and
a second trace portion corresponding to execution of the template code section.

13. The computing system of claim 12, wherein the instructions, when executed, further configure the processor to determine relative line reference data that indicates line numbering relative to the custom code section, wherein the first representation is obtained based on modifying the first trace portion of the stack trace using the relative line reference data.

14. The computing system of claim 13, wherein the instructions, when executed, further configure the processor to store, in the memory, at least one of: the relative line reference data, or line number offset for the custom code section relative to source code line numbering.

15. The computing system of claim 12, wherein formatting the error message to indicate the generic template code error comprises selectively including, in the error message, information from the second trace portion of the stack trace.

16. The computing system of claim 12, wherein formatting the error message to indicate the generic template code error comprises:
determining a modified representation of the second trace portion of the stack trace; and
inserting the modified representation in the error message.

17. The computing system of claim 16, wherein determining the modified representation comprises deleting one or more lines from the second trace portion of the stack trace.

18. The computing system of claim 16, wherein determining the modified representation comprises:
determining generic indicators of one or more active routines that are defined in the template code section of the source code; and
replacing at least parts of the second trace portion with the generic indicators.

19. The computing system of claim 11, wherein the instructions, when executed, further configure the processor to obtain a source map that is generated based on the source code, wherein the location of the error within the source code is determined based on:
the source map; and
indications of stack trace portions corresponding to execution of the custom code section and the template code section, respectively, of the source code.

20. A non-transitory, computer-readable medium storing instructions that, when executed by a processor, configure the processor to:
obtain a stack trace associated with an error detected in connection with execution of a computer program by a processor;
determine a location of the error within source code of the computer program based on the stack trace, wherein the source code contains a template code section and a custom code section;
generate an error message for the error, wherein the generating includes:
in response to determining that the error is located in the custom code section, append a first representation of the stack trace to the error message; and
in response to determining that the error is located in the template code section, format the error message to indicate a generic template code error, and present the error message via a computing device.
